(19) United States
(12) Patent Application Publication
(10) Pub. No.: US 2019/0149731 A1
(43) Pub. Date: May 16, 2019

(54) METHODS AND SYSTEMS FOR LIVE SHARING 360-DEGREE VIDEO STREAMS ON A MOBILE DEVICE

(71) Applicant: Livit Media Inc., Los Angeles, CA (US)

(72) Inventors: Adam BLAZER, Los Angeles, CA (US); Nick CONTINO, West Hollywood, CA (US)

(21) Appl. No.: 16/197,600

(22) Filed: Nov. 21, 2018

Related U.S. Application Data
(63) Continuation of application No. PCT/US2017/034508, filed on May 25, 2017.
(60) Provisional application No. 62/341,564, filed on May 25, 2016.

(51) Int. Cl. H04N 5/232; H04N 21/218; H04N 21/2187; H04N 21/2743; H04N 21/4223; H04L 29/06; H04N 7/18

(52) U.S. Cl. CPC H04N 5/23238; H04N 21/21805; H04N 21/2187; H04N 7/18; H04N 21/4223; H04N 5/232935; H04L 65/605; H04N 21/2743

(57) ABSTRACT

The present disclosure provides methods and systems for live sharing 360-degree video streams on a mobile device by tethering the mobile device to a 360-degree camera source to host live video streams from various venues. A 360-degree video sharing platform may be configured to ingest live video stream from one or more host devices coupled to the 360-degree camera, apply one or more image or video processing techniques, and transmit the processed image or video to one or more viewing devices via the network.

### CROSS-REFERENCE

This application is a continuation of International Application No. PCT/US2017/034508, filed May 25, 2017, which claims priority to U.S. Provisional Application No. 62/341,564, filed on May 25, 2016, each of which applications is entirely incorporated herein by reference.

### BACKGROUND

Live streaming technology enables remote viewers to view live events on their mobile devices. Conventional live streaming platforms on mobile devices are directed to sharing 2D videos and images.

### SUMMARY

Provided herein are methods and systems for live sharing and streaming interactive 360-degree videos via a mobile device.

The system described herein enables users (i.e., live video producers) to share highly immersive 360-degree videos of live events on their respective mobile devices, and also enables a wide range of remote audience to consume immersive 360-degree video streams of live events in real-time, on compatible devices. The remote audience may also interactively adjust their point of view of the 360-degree live video stream, while engaging with other remote viewers on the 360-degree live video platform. These features greatly enhance the immersive experience of live video streaming.

In an aspect, provided is a system for real-time streaming virtual reality (VR). The system can comprise: at least one VR viewing device for viewing live video feeds by a user; a host mobile device tethered or coupled to a 360-degree camera among a plurality of 360-degree cameras positioned at preselected locations at a venue, wherein the plurality of 360-degree cameras are configured to provide live video feeds of the venue; and a server with one or more processors configured to receive the live video feeds from a plurality of the host mobile devices and transmit the live video feeds to the at least one VR viewing device, wherein the plurality of host mobile devices are configured to include an application or logic allowing the user to preview, customize, or select the live video feeds transmitted by the plurality of 360-degree cameras.

In some embodiments, the tethering is accomplished via one or more communication technologies comprising Bluetooth, Wi-Fi, BLE, or peer-to-peer (P2P) networking.

In some embodiments, the viewing device is a head-mounted display (HMD) system. In other embodiments, the VR viewing device is a smartphone.

In some embodiments, the host mobile device is configured to receive raw video feeds from the 360-degree camera and wrap the raw video feeds into a 360-degree range, which is optimized or customized for the at least one VR viewing device.

In some embodiments, at least one of the 360-degree camera includes a plurality of lenses. In some embodiments, the 360-degree camera can further comprise an image processor for performing on-board processing, stitching, and correction of images taken from the plurality of lenses before transmission to the host mobile device.

In some embodiments, the host mobile device can be configured to process the image for optimal or personalized viewing experience by the at least one VR viewing devices, wherein the 360-degree camera does not perform image stitching, and sends raw video feeds taken from each of the plurality of lenses directly to the host mobile device; and wherein the host mobile device is configured to perform the stitching and image correction process by taking the raw video feeds as inputs, and output a single stitched digital spherical and panoramic video feeds in real-time.

In some embodiments, at least one of the host mobile device is configured to receive the raw video feeds taken from the plurality of lenses and transmit the images to the server for post-processing, wherein the server is enabled to stitch together images taken from the plurality of lenses and produce 360-degree videos in real-time.

In some embodiments, at least one of the host mobile device is further configured to determine an optimal 360-degree camera among the plurality of 360-degree cameras to tether based at least on the network bandwidth or network speed.

In some embodiments, at least one VR viewing device comprises a graphical user interface, wherein the graphical user interface is configured to provide previews of the live video feeds from the plurality of 360-degree cameras.

In another aspect, provided is a method of live streaming 360-degree videos to a plurality of VR viewing devices. The method can comprise: detecting a plurality of 360-degree camera sources configured to capture live video feeds; tethering a 360-degree camera source among the plurality of 360-degree camera sources to a host mobile device, wherein the host mobile device is configured to transmit a live video feed from a venue; ingesting, by a server, the live video feed transmitted by the host mobile device; and transmitting, by the server, the live video feed to the plurality of VR viewing devices.

In some embodiments, the tethering is accomplished via one or more communication technologies comprising Bluetooth, Wi-Fi, BLE, or peer-to-peer (P2P) networking.

In some embodiments, at least one of the plurality of VR viewing devices is a head-mounted display (HMD) system. In other embodiments, at least one of the plurality of VR viewing devices is a smartphone.

In some embodiments, at least one of the host mobile device is configured to receive raw video feeds from the 360-degree camera and wrap the raw video feeds into a 360-degree range, which is optimized or customized for the plurality of VR viewing devices.

In some embodiments, at least one of the plurality of 360-degree cameras includes a plurality of lenses.

In some embodiments, at least one of the plurality of 360-degree cameras further comprises an image processor for performing on-board processing, stitching, and correction of images taken from the plurality of lenses before transmission to the host mobile device.

In some embodiments, the host mobile device is configured to process the image for optimal or personalized viewing experience by the plurality of VR viewing devices, wherein the 360-degree camera does not perform image stitching, and sends raw video feeds taken from each of the plurality of lenses directly to the host mobile device; and wherein the host mobile device is configured to perform the stitching and image correction process by taking the raw video feeds as inputs, and output a single stitched digital spherical and panoramic video feeds in real-time.

In some embodiments, the host mobile device is configured to receive raw video feeds taken from the plurality of lenses and transmit the images to the server for post-processing, wherein the server is enabled to stitch together images taken from the plurality lenses and produce 360-degree videos in real-time.

In some embodiments, the host mobile device is further configured to determine an optimal 360-degree camera among the plurality of 360-degree cameras to tether based at least on the network bandwidth or network speed.

In some embodiments, the at least one VR viewing device comprises a graphical user interface, wherein the graphical user interface is configured to provide previews of the live video feeds from the plurality of 360-degree cameras.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein) of which:

FIG. 1 illustrates a virtual reality system in which the concepts described herein may be implemented, according to some embodiments;

FIG. 2 illustrates an environment in which the virtual reality system for cross-platform viewing of 360-degree live videos can be implemented, according to some embodiments;

FIG. 3 illustrates 360-degree live video recording devices for the concepts described herein, according to some embodiments;

FIG. 4 illustrates an implementation of the computer interface for the live sharing concepts described herein, according to some embodiments; and

FIG. 5 illustrates a flow diagram of a process for enabling live streaming of 360-degree video sharing, according to some embodiments.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

By enabling a mobile device to tether to a 360-degree camera, the system described herein provides mobile device users with the ability to produce customized 360-degree live video streams across the network. Remote viewers may consume the 360-degree live video streams with high degree of interactivity, which includes adjusting the 360-degree live video streams to change his or her preferred field of view.

As used herein, a “360-degree camera” generally refers to a camera with capabilities of taking 360-degree field of view (FOV) shots in the horizontal plane, or with a visual field that covers, or substantially covers, the entire sphere.

As used herein, “360-degree video” generally refers to video recordings in panorama, where the view in every direction is recorded at the same or substantially the same time, shot using a 360-degree camera or a plurality of cameras. The viewer can have control of the viewing direction during the playback.

### Methods for Producing 360-Degree Live Video Streams

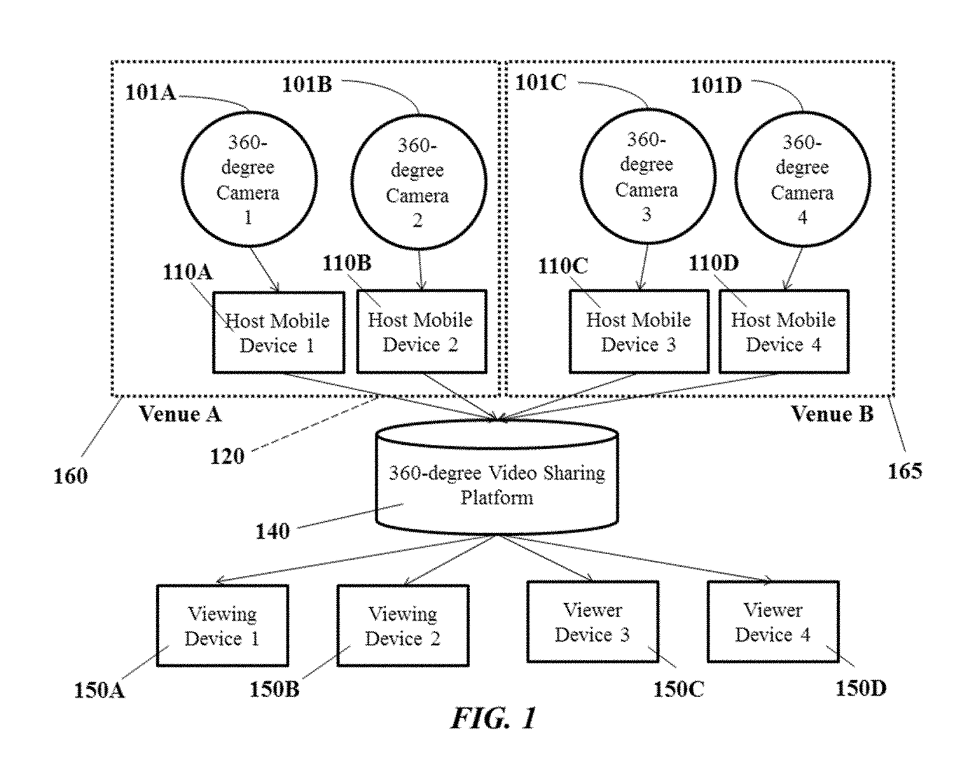

FIG. 1 is an illustration of a system in which the concepts described herein may be implemented. The system may include one or more 360-degree cameras 101A-D (also can be referred to as 101), one or more host mobile devices 110A-D (also can be referred to as 110), a 360-degree video sharing platform 140, and one or more viewing devices 150A-D (also can be referred to as 150).

Each 360-degree camera devices 101 may be placed at the same location or at multiple distinct locations. For example, one 360-degree camera 101A can be positioned at a live event at venue A 160, while another 360-degree camera 101C can be positioned at a live event at venue B 165, which is distinct from venue A 160. This configuration enables remote users with viewing devices 150 to select one or more 360-degree live video streams of their choice among multiple different streams originating from various different venues (e.g., Venue A and Venue B). Remote users on viewing devices 150 may also seamlessly switch back and forth between one 360-degree live video stream and another 360-degree live video stream.

In another example, multiple 360-degree cameras 101 are placed at the same venue, but positioned at different distance and height combinations (i.e., at different [x, y, z] coordinates) at the given venue. This can enable the remote viewers of the 360-degree live video stream to view an event at the venue from multiple different perspectives of their choice. For example, multiple 360-degree cameras 101 can be placed at each side of a stadium at a sports event (e.g., a baseball game), and viewers may optionally switch through multiple different streams to view the 360-degree videos from their preferred perspective. Additional 360-degree cameras may be included in the configuration to increase viewing options for remote viewers.

The host mobile devices 110 are configured to tether to the 360-degree cameras 101 via a wireless communication link (e.g., Wi-Fi, Bluetooth, or other peer-to-peer communication technology), wherein the 360-degree live video streams captured by the 360-degree cameras are transmitted to the host mobile devices 110. In some embodiments, the 360-degree cameras have different features, functions, or image quality. For example, 360-degree camera 1 (101A) may not have the same functionalities or features compared to those of 360-degree camera 2 (101B), and users of the remote viewing (i.e., consuming) devices 150 may have the option to choose which streams to view based on the preferred image quality, features, and functionality. If the viewing devices 150 are operating in a poor networking environment (i.e., low bandwidth), the users may have an option to select one or more 360-degree cameras 110 that may provide better streaming experience under those network circumstances. The remote viewers may have the flexibility of playing any given 360-degree live video feed that is optimized for specific viewing conditions at given remote locations.

In an alternative embodiment, the host mobile device 110 may be configured to automatically tether to a 360-degree source camera—from a plurality of 360-degree source cameras 101A-D—that may provide the best viewing experience. For example, the mobile application installed or resident on the host mobile devices 110 may be configured to determine, based at least on one or more factors—including, but not limited to network connectivity, available bandwidth, screen resolution requirements, processing power of the host mobile devices, available wireless connection methods—which one of the 360-degree cameras to tether to, among the plurality of 360-degree cameras 110. Viewing experience may depend on the speed and reliability of the network, or the total available bandwidth at any given time.

“Tethering” herein generally refers to the concept of sharing the capabilities of one device with another device, without wired connection between the two devices. Tethering may be accomplished through various communications technology, which includes Bluetooth, IEEE 802.11 (“Wi-Fi”), and near field communication (“NFC”), wherein the wireless communication link 120 may be established via one or more of the various aforementioned communications technology. The optimal communications technology may depend on the capabilities and given features of the respective 360-degree cameras 101A-D.

The host mobile devices 110 may be configured to include an application or logic to allow users to preview, customize, or select the 360-degree live video stream data transmitted by one of the tethered 360-degree cameras 101. In some embodiments, the application is a mobile application downloadable via one or more app stores. The application may be configured to provide the host mobile device users with a graphical user interface to preview the live video feeds. The live video feeds may also be edited or the viewing angle of the live video feeds may be modified or adjusted via the user interface provided by the application, for example. The application may also be configured to provide the host mobile device users with functionalities to select 360-degree cameras based on the streaming requirements.

In some embodiments, the 360-degree camera 110 tethered to the host mobile devices 110 is a single-lens camera. A single-lens camera may transmit raw, live stream videos from the camera to the tethered host mobile device 110. The host mobile device 110 may be configured to receive raw data from a 360-degree camera and wrap the video into a 360-degree range, which may be optimized for the viewing devices 150. One or more processors onboard the host mobile devices 110 may be configured to execute such image processing algorithms.

In alternative embodiments, the host mobile device 110 is tethered to a multi-lens 360-degree camera 101, which may carry a plurality of lenses. The multi-lens 360-degree camera may be capable of performing on-board processing, stitching, and correction of images taken from its multiple lenses by performing on-board image processing before transmitting it to the host mobile device. The host mobile device 110 may take the received video feed and transmit the live video feed to the 360-degree video sharing platform 140. Optionally, the host mobile device 110 may be configured to process the image for optimal viewing experience by the viewing devices 150.

Alternatively, the host mobile devices 110 can be tethered to a multi-lens 360-degree camera, which may lack on-board image processing capabilities. Consequently, the camera may not perform image stitching or other types of image processing, and sends raw video streams taken from each of the plurality of lenses directly to the host mobile device 110. For these types of cameras, the host mobile device may be configured to perform the stitching and/or image correction process by taking the raw video streams as inputs, and output a single stitched digital spherical and panoramic videos in real-time or near real-time. Optionally, the host mobile device 110 may be configured to receive the raw video streams taken from the multiple lenses and transmit the images to the 360-degree video sharing platform 140 for post-processing. Under such configuration, the 360-degree video sharing platform 140 can be enabled to stitch together the multiple images taken from a plurality of cameras and produce 360-degree videos in real-time or near real-time.

The host mobile devices 110 may include a touch screen display. The user of the host mobile device (i.e., live video producer) can, for example, spin the preview image by dragging a finger across the touch screen display of the host mobile device 110. In some embodiments, the user of the host mobile devices 110 may spin the preview image by moving or rotating the host mobile device around. For example, the preview image displayed on the host mobile device 110 may directly track the movement of the host mobile device. Therefore, if the orientation of the host mobile device turns 90 degrees to the east, the preview live stream image may also turn 90 degrees east and alter the field of view.

The host mobile devices 110 may be configured to include an application or logic to allow the user to stream the selected 360-degree live video from his or her host mobile device 110. The application or logic can be configured to initiate a connection with a 360-degree video sharing platform 140.

The 360-degree video sharing platform 140 can be further configured to send notifications (i.e., push notifications) to select remote viewers on viewing devices 150. In some embodiments, one or more viewing devices 150A-D (i.e., consuming devices) may receive notification of a 360-degree live video stream that is produced by one or more of the host mobile devices 110. The notification may be in a form of a push notification, a message, an update in an application installed on the viewing devices 110, and any other well-known notification methods.

The viewing devices 150 may be mobile devices. In some examples, the viewing devices 150 may be a head mounted display (HMD), which can track the orientation of the wearer's head. Such configuration can show immersive 360-degree video that responds to user's movement, including displaying one or more parts of the image/video which may appear in the direction in which the viewer is facing.

In some embodiments, the viewing devices 150 may include a touch display that is configured to enable the user of such device to swipe across the display, for example, to rotate the field of view (FOV) of the 360-degree live video stream. The remote users using the viewing devices 150 may rotate the FOV of 360-degree live video streams, independently from the original FOV of the live videos produced or selected by the host mobile devices 110. This configuration can provide extra degree of flexibility for the viewers of the live video stream, since the FOV of the host mobile devices does not necessarily limit the FOV of the viewing devices 150.

### Methods for Streaming Live Stream 360-Degree Videos to One or More Users

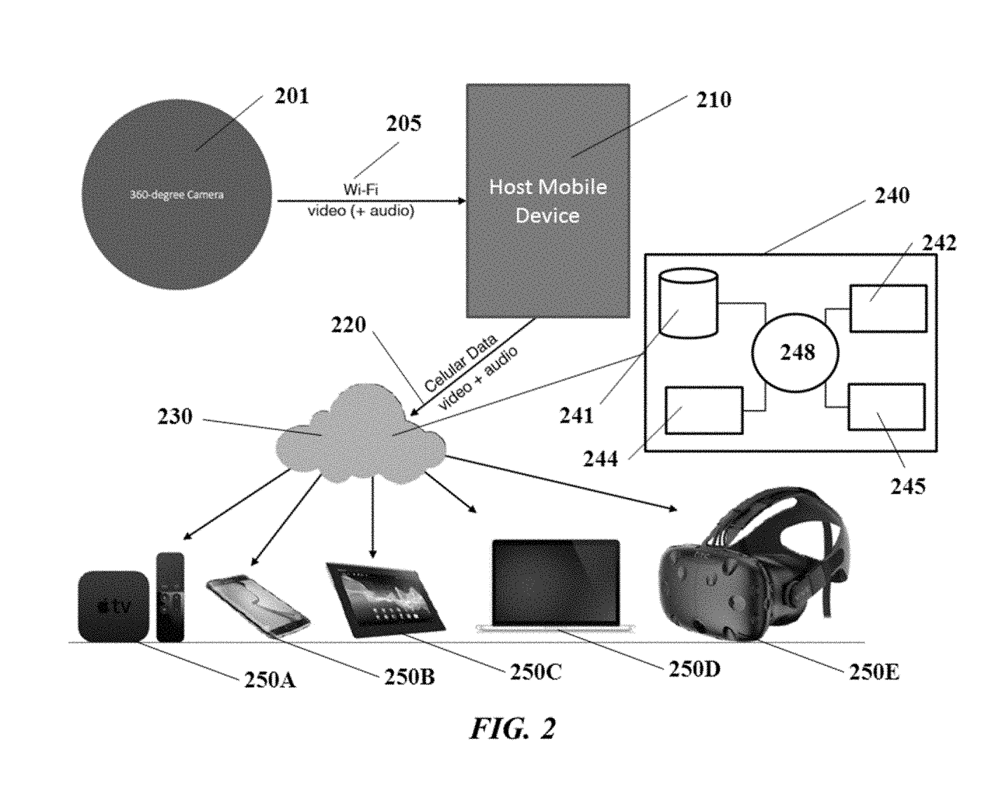

FIG. 2 illustrates an environment in which the disclosed VR system is implemented in accordance with some embodiments described herein. The VR system may provide cross-platform support for sharing 360-degree live video streams.

In some embodiments, a 360-degree camera 201 is configured to transmit video and/or audio data to a mobile device 210 via wireless communication (e.g., Wi-Fi, Bluetooth), wherein the mobile device 210 is tethered to the 360-degree camera 210. The host mobile device 210 may be any one of the wide range of available hand-held computing device types. For example, such computing devices may include, but is not limited to, smart phones, tablets, laptop computers, wearable computing devices, head-mounted displays (HMDs) and any other computing device that can be carried, worn, or held by a user.

In some embodiments, the 360-degree camera 201 has the ability to transmit audio via the wireless communication link 205, wherein the mobile device 210 may be configured to optionally take or obtain the audio data transmitted by the 360-degree camera 201 as the audio source for the live video stream.

In another example, the 360-degree camera lacks the ability to transmit audio via the wireless communication link 205, wherein the mobile device 210 may be configured to optionally take the audio input unit of the mobile device 210 directly as the audio source for the live video stream.

The mobile device 210 may be configured to communicate with the computer system 240 (e.g., 360-degree video sharing platform 140) via a communication network (“network”) 230. The computer system 240 can be operatively coupled to a computer network (“network”) 230 with the aid of the communication interface 242.

The network 230 may be a communication pathway between the host mobile device 210 and the viewing devices 250 (e.g., 250A, 250B, 250C, 250D, 250E). The network 230 may comprise any combination of local area and/or wide area networks using both wireless and/or wired communication systems. For example, the network 230 may include the Internet, as well as mobile telephone networks. In one embodiment, the network 230 uses standard communications technologies and/or protocols. Hence, the network 230 may include links using technologies such as Ethernet, 802.11, worldwide interoperability for microwave access (WiMAX), 2G/3G/4G mobile communications protocols, asynchronous transfer mode (ATM), InfiniBand, PCI Express Advanced Switching, etc. Other networking protocols used on the network 230 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), and the like. The data exchanged over the network can be represented using technologies and/or formats including image data in binary form (e.g., Portable Networks Graphics (PNG)), the hypertext markup language (HTML), the extensible markup language (XML), etc. In addition, all or some of links can be encrypted using conventional encryption technologies such as secure sockets layers (SSL), transport layer security (TLS), Internet Protocol security (IPsec), etc. In another embodiment, the entities on the network can use custom and/or dedicated data communications technologies instead of, or in addition to, the ones described above. The network 230 can include one or more computer servers, which can enable distributed computing, such as cloud computing. The network 230, in some cases with the aid of the computer system 240, can implement a peer-to-peer network, which may enable devices coupled to the computer system 240 to behave as a client or a server.

In some embodiments, a computer system 240 (e.g., 360-degree video sharing platform 140) is programmed or otherwise configured to ingest, process, and/or share 360-degree live video streams across multiple different computer platforms. Such live stream viewing platforms include, but is not limited to, set top boxes 250A (e.g., Apple TV), smart phones 250B, tablets 250C, laptop computers 250D, wearable computing devices 250E, and any other computing device that can be carried, held, or worn by a user. Multiple users may be viewing the 360-degree live stream video on a variety of different platforms, and the mobile application or logic can be configured to be able to automatically detect the type of viewing device and optimize the video stream format for the particular viewing device. The mobile application may be configured to offer cross-platform functionality.

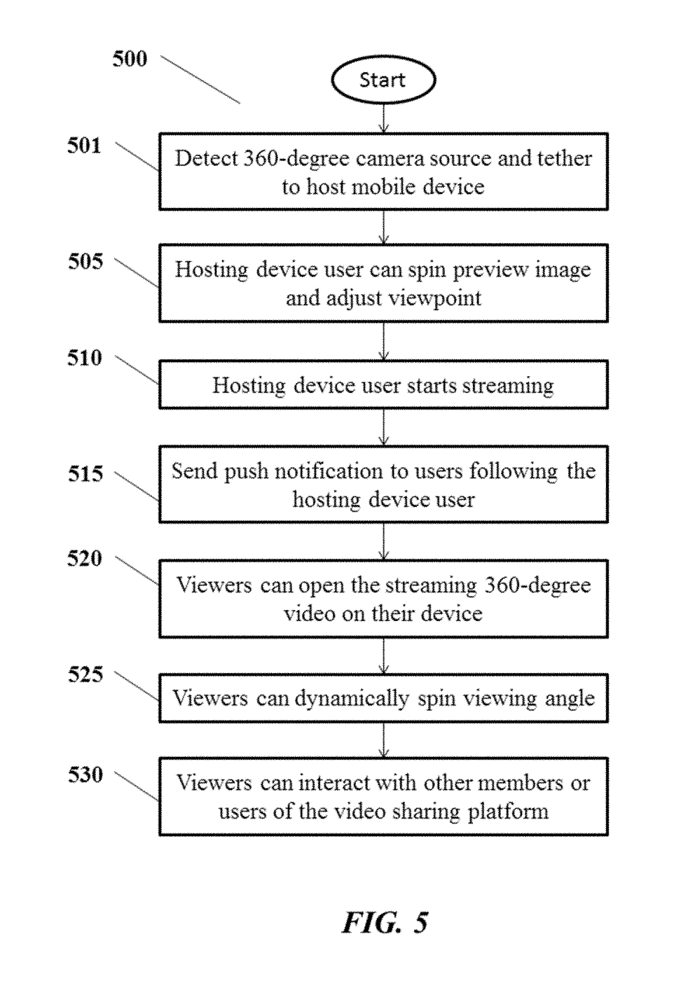

The computer system 240 can regulate various aspects of FIGS. 1-2 of the present disclosure, such as, for example, the 360-degree cameras 101A-D, host mobile devices 110A-D, the 360-degree video sharing platform 140, and one or more operations of the flow chart illustrated in FIG. 5. In other embodiments, the computer system may illustrate one or more host mobile devices 110 or viewing devices 150. For example, the components and functionalities of the computer system 240 may illustrate one or more computer devices or mobile devices described herein.

The computer system 240 includes a central processing unit (CPU, also “processor” and “computer processor” herein) 248, which can be a single core or multi core processor, or a plurality of processors for parallel processing. The computer system 240 also includes memory or memory location 244 (e.g., random-access memory, read-only memory, flash memory), electronic storage unit 241 (e.g., hard disk), communication interface 242 (e.g., network adapter) for communicating with one or more other systems, and peripheral devices 245, such as cache, other memory, data storage and/or electronic display adapters. The memory 244, storage unit 241, interface 242 and peripheral devices 245 are in communication with the CPU 248 through a communication bus (solid lines), such as a motherboard. The storage unit 241 can be a data storage unit (or data repository) for storing data.

The CPU 248 can execute a sequence of machine-readable instructions, which can be embodied in a program or software. The instructions may be stored in a memory location, such as the memory 244. The instructions can be directed to the CPU 248, which can subsequently program or otherwise configure the CPU 248 to implement methods of the present disclosure. Examples of operations performed by the CPU 248 can include fetch, decode, execute, and writeback.

The CPU 248 can be part of a circuit, such as an integrated circuit. One or more other components of the system 240 can be included in the circuit. In some cases, the circuit is an application specific integrated circuit (ASIC).

The storage unit 241 can store files, such as drivers, libraries and saved programs. The storage unit 241 can store user data, e.g., user preferences and user programs. The computer system 240 in some cases can include one or more additional data storage units that are external to the computer system 240, such as located on a remote server that is in communication with the computer system 240 through an intranet or the Internet.

Methods as described herein can be implemented by way of machine (e.g., computer processor) executable code stored on an electronic storage location of the computer system 240, such as, for example, on the memory 244 or electronic storage unit 241. The machine executable or machine readable code can be provided in the form of software. During use, the code can be executed by the processor 248. In some cases, the code can be retrieved from the storage unit 241 and stored on the memory 244 for ready access by the processor 248. In some situations, the electronic storage unit 241 can be precluded, and machine-executable instructions are stored on memory 244.

In some embodiments, methods as described herein can be implemented by way of machine (e.g., computer processor) executable code stored on an electronic storage location of the host mobile device 210 or any one of the viewing devices 250A-E. The machine executable or machine readable code can be provided in the form of software. During use, the code can be executed by the processor of the host mobile device 210 or any one of the viewing devices 250A-E.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 240, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 240 can include or be in communication with an electronic display (e.g., touch screen display of a mobile phone) that comprises a user interface (UI) for displaying, for example, the results of the push notification of 360-degree live video stream or displaying other 360-degree live video streams or their associated features and functionalities. Examples of UI's include, without limitation, a graphical user interface (GUI) and web-based user interface, and may be part of any one of the mobile computing devices that are referred to herein 250A-E.

In some embodiments, the computer system 240 can include or be in communication with a head mounted display (HMD), wherein the HMD can be the direct source for viewing the 360-degree stream if the HMD has compatible software to display it natively (i.e., Oculus Rift, HTC Vive).

In another embodiment, the computer system 240 can include or be in communication with a mobile device that can be inserted into a head mounted display 250E (e.g., Samsung Gear VR). The remote viewers may view the 360-degree live video stream in stereoscopic view via, for example, head-mounted display (HMD) systems.

Methods and systems of the present disclosure can be implemented by way of one or more algorithms. An algorithm can be implemented by way of software upon execution by the central processing unit 248. For example, some embodiments use the algorithm or process illustrated in FIG. 2 or other algorithms provided in the associated descriptions. Other embodiments may use algorithms similar to that of FIG. 5 and its associated descriptions.

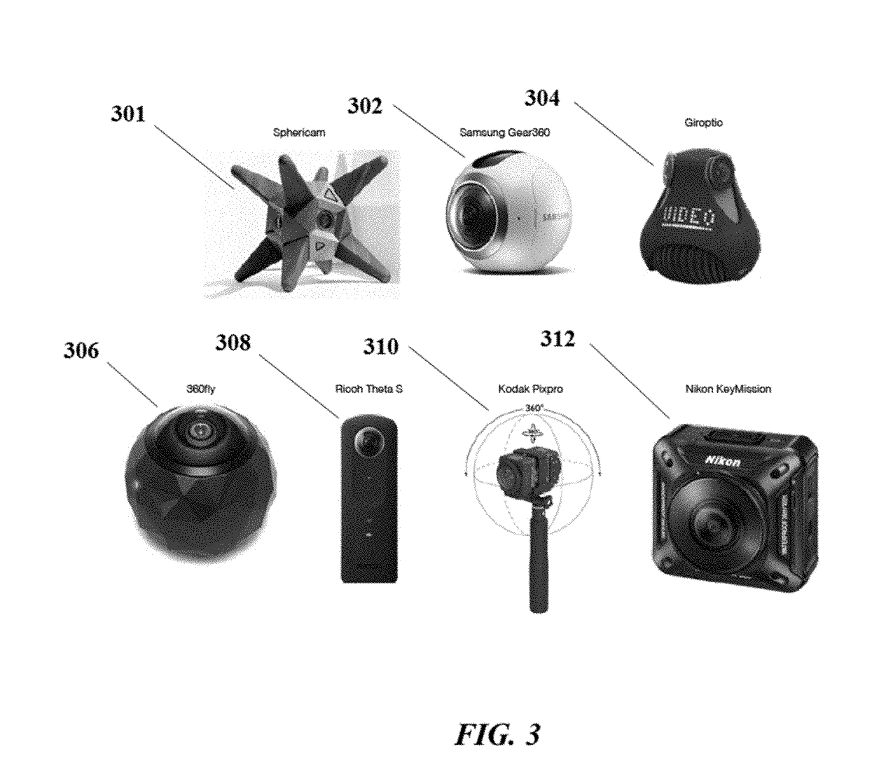

FIG. 3 illustrates examples of 360-degree live video recording devices that are described in the concepts herein. In some embodiments, the camera source in FIG. 2 (360-degree camera 201) can be a single-lens or multiple-lens configuration. For example, 360 fly camera 306 is a single-lens camera while the Sphericam 301 is a multi-lens camera. Multiple-lens camera sources may have to go through a process called “stitching” which blends the images of two or more lenses into a single view within a video player.

In some embodiments, the stitching process for the multiple-lens cameras occurs before the video is streamed, for example, on the host mobile device 210. The host mobile device 210 may be configured to process the video stream that is transmitted from the 360-degree camera sources 301-312.

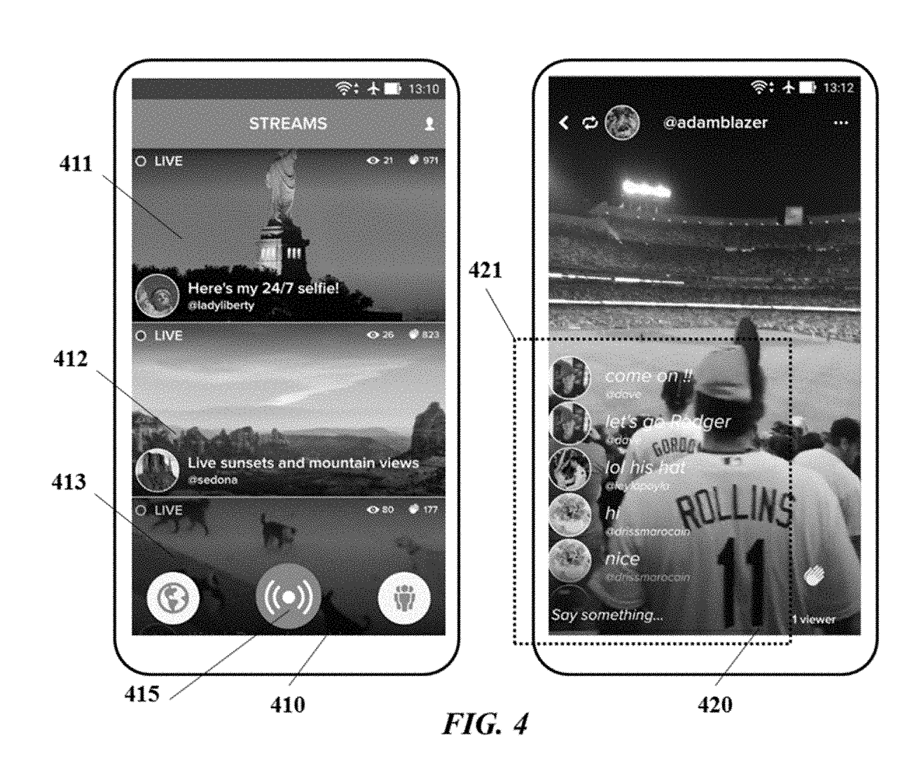

FIG. 4 illustrates an exemplary implementation of the computer interface for the live sharing concepts described herein. In some embodiments, the computer interface is a graphical user interface. In some embodiments, the computer interface is a touch screen display. As illustrated, one interface 410 includes one or more live streams (e.g., streams 411, 412, 413) transmitted from remote locations. Viewers can preview the live streams before determining which streams to view. For example, the viewer of the interface 410 may have three 360-degree live video streams to choose from (referring to FIG. 4 411, 412, 413) each represented by a preview screen of the respective live streams from distinct remote locations. In some embodiments, the preview screen represents live video streams. The viewers may view the selected stream on a head-mounted display (HMD) or other 360-degree or virtual reality enabled devices for a fully immersive experience.

As illustrated in another interface 420, the viewers who are viewing the 360-degree live video stream may also have an option to chat 421 with other viewers of the same stream. For example, a chat screen 421 may appear at one or more corners of the user interface and the chat screen may be configured to show a stream of user comments/replies, etc. Optionally, the total number of viewers 410 of the given live stream may be displayed, which may indicate the popularity of the particular live stream. Other statistics, information, or metadata related to the live stream may be displayed.

FIG. 5 illustrates an exemplary flow diagram of a process for enabling live sharing of interactive 360-degree video streams 500 with remote viewers. In some embodiments, the host mobile device 210 is configured to seek connection to a compatible 360-degree camera 201.

In some embodiments, the host mobile device 210 is configured to detect a compatible 360-degree camera source 201 and establish wireless connection to the 360-degree camera source (operation 501). The wireless connection may include, but not limited to one or more of Wi-Fi, Bluetooth, BLE, peer-to-peer (P2P) connections. The 360-degree camera 201 may come in many different forms, and the user may select which 360-degree camera to tether to, if more than one 360-degree cameras are in the vicinity.

Once tethering is establish, the host mobile device 210 may be configured to display a preview of the image transmitted via the 360-degree cameras 201. The host mobile device 210 user may spin the preview image or video via, for example, a touch display, and adjust the viewpoint (operation 505).

In operation 510, after the host mobile device 210 user has finalized the configuration of the 360-degree live video, the user may start producing a live stream by touching the “start” button on the touch display of the host mobile device 210. The user may also initiate the live stream by touching any part of the touch screen display. This process can initiate a “start stream” process and send a signal to the server (e.g., 360-degree video sharing platform).

Remote viewers with viewing devices (e.g., viewing device 150) may have an option to follow or subscribe to one or more live video producers or other users broadcasting from the host mobile device 110. In some embodiments, the viewing devices 150 may receive a push notification from the server (operation 515), which notifies the viewers of the new incoming live 360-degree video stream, or any other live 360-degree videos of interest to the user.

In operation 520, viewers can open the streaming 360-degree video on their mobile device, web browser, or head-mounted display (HMD). The viewers can spin the live video stream in the same fashion that the host mobile device video streamer can preview the 360-degree live video (operation 525).

In operation 530, viewers can interact with other members on the platform through chat and clapping functions. For example, remote viewers watching the same live 360-degree video stream, or watching streams related to the same event, can chat amongst themselves and share reactions during the given live stream or event.

In various other implementations, the 360-degree live video sharing and streaming method 500 described herein may only include operations 501, 510, 515, 520.

In alternative implementations, the 360-degree live video sharing method 500 may omit one or more of the operations described herein.

In various other implementations, the users of the viewing device in operation 520 may have an option to start streaming their own 360-degree live video to one or more people. For example, in some embodiments, the mobile application resident or installed on the viewing devices may be configured to enable any viewers to also host 360-degree live videos from their respective remote locations.

As used herein, “or” is inclusive and not exclusive, unless expressly indicated otherwise by context. Therefore, “A or B” means “A, B, or both,” unless expressly indicated otherwise or indicated otherwise by context. Moreover, “and” is both joint and several, unless expressly indicated otherwise or indicated otherwise by context.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A real-time streaming virtual reality (VR) system, comprising:
at least one VR viewing device for viewing live video feeds by a user;
a host mobile device tethered or coupled to a 360-degree camera among a plurality of 360-degree cameras positioned at preselected locations at a venue, wherein the plurality of 360-degree cameras are configured to provide live video feeds of the venue; and
a server with one or more processors configured to receive the live video feeds from a plurality of the host mobile devices, including the host mobile device, and transmit the live video feeds to the at least one VR viewing device, wherein the plurality of host mobile devices are configured to include an application or logic allowing the user to preview, customize, or select the live video feeds transmitted by the plurality of 360-degree cameras.

2. The VR system in claim 1, wherein the tethering is accomplished via one or more communication technologies comprising Bluetooth, Wi-Fi, BLE, or peer-to-peer (P2P) networking.

3. The VR system in claim 1, wherein the VR viewing device is a head-mounted display (HMD) system or a smartphone.

4. (canceled)

5. The VR system in claim 1, wherein the host mobile device is configured to receive raw video feeds from the 360-degree camera and wrap the raw video feeds into a 360-degree range, which is optimized or customized for the at least one VR viewing device.

6. The VR system in claim 1, wherein the 360-degree camera includes a plurality of lenses.

7. The VR system in claim 6, wherein the 360-degree camera further comprises an image processor for performing on-board processing, stitching, and correction of images taken from the plurality of lenses before transmission to the host mobile device.

8. The VR system of claim 6, wherein the host mobile device is configured to process the image for optimal or personalized viewing experience by the at least one VR viewing devices, wherein the 360-degree camera does not perform image stitching, and sends raw video feeds taken from each of the plurality of lenses directly to the host mobile device; and wherein the host mobile device is configured to perform the stitching and image correction process by taking the raw video feeds as inputs, and output a single stitched digital spherical and panoramic video feeds in real-time.

9. The VR system of claim 6, wherein the host mobile device is configured to receive the raw video feeds taken from the plurality of lenses and transmit the images to the server for post-processing, wherein the server is enabled to stitch together images taken from the plurality of lenses and produce 360-degree videos in real-time.

10. The VR system of claim 1, wherein host mobile device is further configured to determine an optimal 360-degree camera among the plurality of 360-degree cameras to tether based at least on the network bandwidth or network speed.

11. The VR system of claim 1, wherein the at least one VR viewing device comprises a graphical user interface, wherein the graphical user interface is configured to provide previews of the live video feeds from the plurality of 360-degree cameras.

12. A method of live streaming 360-degree videos to a plurality of VR viewing devices, comprising:
detecting a plurality of 360-degree camera sources configured to capture live video feeds;
tethering a 360-degree camera source among the plurality of 360-degree camera sources to a host mobile device, wherein the host mobile device is configured to transmit a live video feed from a venue;
ingesting, by a server, the live video feed transmitted by the host mobile device; and
transmitting, by the server, the live video feed to the plurality of VR viewing devices.

13. The method of claim 12, wherein the tethering is accomplished via one or more communication technologies comprising Bluetooth, Wi-Fi, BLE, or peer-to-peer (P2P) networking.

14. The method of claim 12, wherein at least one of the plurality of VR viewing devices is a head-mounted display (HMD) system or a smartphone.

15. (canceled)

16. The method of claim 12, wherein the host mobile device is configured to receive raw video feeds from the 360-degree camera and wrap the raw video feeds into a 360-degree range, which is optimized or customized for the plurality of VR viewing devices.

17. The method of claim 12, wherein the 360-degree camera includes a plurality of lenses.

18. The method of claim 17, wherein the 360-degree camera further comprises an image processor for performing on-board processing, stitching, and correction of images taken from the plurality of lenses before transmission to the host mobile device.

19. The method of claim 17, wherein the host mobile device is configured to process the image for optimal or personalized viewing experience by the plurality of VR viewing devices, wherein the 360-degree camera does not perform image stitching, and sends raw video feeds taken from each of the plurality of lenses directly to the host mobile device; and wherein the host mobile device is configured to perform the stitching and image correction process by taking the raw video feeds as inputs, and output a single stitched digital spherical and panoramic video feeds in real-time.

20. The method of claim 17, wherein the host mobile device is configured to receive raw video feeds taken from the plurality of lenses and transmit the images to the server for post-processing, wherein the server is enabled to stitch together images taken from the plurality lenses and produce 360-degree videos in real-time.

21. The method of claim 12, wherein the host mobile device is further configured to determine an optimal 360-degree camera among the plurality of 360-degree cameras to tether based at least on the network bandwidth or network speed.

22. The method of claim 12, wherein the at least one VR viewing device comprises a graphical user interface, wherein the graphical user interface is configured to provide previews of the live video feeds from the plurality of 360-degree cameras.
